(19) United States
(12) Patent Application Publication
(10) Pub. No.: US 2010/0101670 A1
(43) Pub. Date: Apr. 29, 2010

(54) ELECTRICAL MICROVALVE AND METHOD OF MANUFACTURING THEREOF

(75) Inventors: David Juncker, Montreal (CA); Vito Logiudice, Pierrefonds (CA); Matthieu Nannini, Montreal (CA)

Correspondence Address: BERESKIN AND PARR LLP/S.E.N.C.R.L., s.r.l., 40 KING STREET WEST, BOX 401, TORONTO, ON, M5H 3Y2, CA

(73) Assignee: MCGILL UNIVERSITY, Montreal, QC (CA)

(21) Appl. No.: 12/513,381

(22) PCT Filed: Nov. 5, 2007
(86) PCT No.: PCT/CA2007/001997

§ 371 Date: Sep. 21, 2009

Related U.S. Application Data
(60) Provisional application No. 60/864,268, filed on Nov. 3, 2006.

(51) Int. Cl. F15C 1/06; F16K 31/02; B44C 1/22

(52) U.S. Cl. 137/833; 251/129.04; 216/13

(57) ABSTRACT

The present invention relates to a microvalve for controlling a fluid flow in a microchannel, to a microfluidic circuit using the microvalve, and to a manufacturing method thereof. The microvalve has a first electrode located on a portion of the microchannel, a second electrode over the microchannel and substantially aligned with the first electrode forming a membrane with substantially no resilience. In function, upon application of an electric force on the first and second electrodes, the second electrode draws nearer the first electrode, thus obstructing the microchannel. The microfluidic circuit comprises multiple microchannels and at least one microvalve affixed to one of the multiple microchannels, wherein the at least one microvalve is adapted to indirectly actuate a flexible valve adapted to regulate a flow of fluid in another one of a multiplicity of microchannels.

### FIELD OF THE INVENTION

The present invention generally relates to the field of microfluids. More specifically, the invention relates to a microvalve for use in a microfluidic device and to a method of manufacturing an electrical microvalve.

### BACKGROUND OF THE INVENTION

Lab-on-a-chip and micro-total-analysis systems have been experiencing a huge increase in interest in the biomedical and chemistry area during the last decade. Lots of work has been done towards the development of new technologies enabling labs to be shrunk and integrated onto single chips. This emerging technology has proven to be very promising, and is often referred as microfluidics. Microfluidics allows fluid flow control and mix of fluids on chips using microchannels, in which fluids are injected. Such chips integrate many functions on a single substrate which not only allows an entire experiment to be built on a chip, but also allows a large amount of parallel experiments to be performed using very small volumes of fluids in a limited amount of time.

Microfluidic circuits require microvalves, i.e. tiny valves that are the key building blocks for making complex microfluidics integrated circuits. Microvalves are used to direct and pump fluids. Typically, the microvalve is used to block the passage of the fluid in the microchannel. Many configurations of microvalve have been investigated in prior art references.

One of the types of microvalve is the pressure actuated flexible microvalve which is also referred to as pneumatic valve and which is key component of so called multilayer soft lithography (MSL) microfluidic circuits. In such a type of microvalve, the microvalve typically includes a flexible membrane, which is forced to block a channel by applying a pressure thereto. Upon release of the pressure, the membrane recedes and allows passage of the fluid in the microchannel. The pressure can be transmitted pneumatically using gases or hydraulically using liquids. Although effective, this technology is bulky, as it requires a separate source of pressure for every single independent microvalve. European Patent Application 0 845 603, filed by Xerox Corporation describes such an air-actuated microvalve system and a method of production of such microvalves.

Another type of microvalve also commonly known is the electrically actuated microvalve. Such microvalve uses electricity to function. Electrically actuated microvalves are basically composed of two electrodes, separated by an elastomeric substance. This type of microvalve includes two subcategories: the normally open microvalve and the normally closed microvalve. The normally open microvalve is located along the microchannel and requires electricity to close the microchannel, while the normally closed microvalve is located adjacent to the microchannel and requires electricity to open the microchannel. International Patent Application WO 2006/044458 to University of Virginia Patent Foundation depicts and describes an example of a normally closed electrically actuated microvalve, while United States Patent Application 2003/0080442 to Fluidigm Corp. and United States Patent Application 2002/0109114 to California Institute of technology describe a normally-open electrically actuated microvalve. Another interesting reference in the art is United States Patent Application 2006/0118895 to Fluidigm Corp., which describes both normally open and normally closed electrically actuated microvalve. However, in this Fluidigm patent, the design of the microvalve causes important stress on electrodes and elastomeric material, which is not desirable, as it seriously reduces the lifetime of the microvalve, necessitates high voltage (HV) for opening and closing the valve, and slows down the actuation speed.

However, there are numerous problems with both the normally open and the normally closed electrically actuated microvalves of the prior art. More particularly, for the normally open electrically actuated microvalve, the microchannel within which the sample fluid is to flow in is molded within the elastomeric substance. Furthermore, when a conductive liquid fills the valve, normally open valves have the drawback of stopping proper operation under DC actuation and require high-frequency AC actuation. Another drawback, is that the normally open electrically actuated microvalve of the prior art, such as those described in United States Patent Application US2002/0109114 to Fluidigm Corp. necessitates a very high voltage of 1600V for closure which makes its use quite impractical. As for the normally-closed electrically actuated microvalve, even though its manufacturing is simpler than for the direct electrically actuated microvalve, it needs to be rigid to prevent flow of liquid which makes it difficult to actuate it, thus also requiring excessively high voltages.

More recently, direct electrical actuation of valves has been shown, which allows high-density integration of microfluidics. However, because the electrical fields are applied directly to conductive solutions, a DC voltage cannot be used and high frequency AC voltages are required. In the example published by Bansal et al., titled “A class of low voltage, elastomer-metal ‘wet’ actuators for use in high density microfluidics” in Lab on a chip volume 7, pages 164-16, the valves are 5 μm deep only, large (600 μm in diameter) and slow (up to 5 s for closing), and have not been used with pressurized liquids. Faster actuation and deeper channels necessitate higher voltages, but excessive heating is likely to become an issue. The fabrication process hitherto requires multiple difficult processing steps and makes it difficult to produce disposable chips. Finally, the conduits are too small to manipulate cells.

There is therefore a need for an electrical microvalve that is simpler to manufacture, which can function over a longer period of time, which can be actuated with lower voltages, DC current, and for which the actuation does not depend on the composition of the sample fluid.

### SUMMARY OF THE INVENTION

In accordance with an embodiment of the present invention, there is provided a microvalve for a microchannel. The microvalve comprises first and second electrodes. The first electrode is affixed to a portion of the microchannel, while the second electrode is located over the microchannel, forms a membrane demonstrating substantially no resilience, and is substantially aligned with the first electrode. Upon electrical actuation of the first and second electrodes, the membrane is forced within the microchannel so as to obstruct the microchannel. A lid adapted to support the membrane may also be provided.

In accordance with another embodiment, the present invention relates to a method of manufacturing a microvalve. The method of the present invention proceeds with affixing a first electrode on a microchannel. Then, the method pursues with a step of applying a dielectric substance covering at least a portion of the microchannel overlooking the first electrode. Afterwards, the method includes a step of affixing a second electrode over the dielectric substance in such a manner that the second electrode is substantially aligned with the first electrode.

In accordance with yet another embodiment, the present invention relates to a microfluidic circuit. The microfluidic circuit comprises multiple microchannels and at least one microvalve affixed to one of the multiple microchannels. The at least one microvalve is adapted to indirectly actuate a flexible valve which regulates a flow of fluid in another one of a multiplicity of microchannels.

### BRIEF DESCRIPTION OF DRAWINGS

These and other features of the present invention will become more apparent from the following description in which reference is made to the appended drawings wherein:

FIG. 1 is a cross-sectional side view of a microvalve in a non-activated state in accordance with an embodiment of the present invention.

FIG. 2 is a cross-sectional side view of the microvalve of FIG. 1 in an activated state.

FIGS. 3a-e are manufacturing steps of a microchannel of the microvalve of FIG. 1.

FIGS. 4a-b are manufacturing steps of a second electrode of the microvalve of FIG. 1.

FIGS. 5a-f are manufacturing steps of a membrane in accordance with an embodiment of the present invention.

FIGS. 6a-c are partial cross-sectional side views of a microchannel in accordance with other embodiments of the present invention.

FIG. 7 is a top view of the microvalve of FIG. 1.

FIG. 8 is a cross-sectional side view of a microvalve in accordance with another embodiment of the present invention.

FIG. 9 is a cross-sectional side view of a microvalve having a membrane in accordance with another embodiment of the present invention.

FIGS. 10a-b are perspective views of examples of uses of the microvalve of FIG. 1 in microfluidic circuit for indirect actuation of a pneumatic valve.

FIG. 11 a-b are cross-sectional views of another embodiment of the microvalve of the present invention.

FIGS. 12a-b are cross-sectional views of another embodiment of the present invention.

FIG. 13 is an exploded schematic view of a microfluidic circuit in accordance with another aspect of the present invention.

### DETAILED DESCRIPTION OF THE INVENTION

Miniaturization, integration and parallelization (MIP) has driven the (micro) electronic revolution and has started to bear strongly on the life sciences, and already revolutionized gene expression profiling with DNA microarrays and genotyping with high throughput sequencers. The cell is the minimal physiological functional unit, yet of extraordinary complexity as it contains 23000 genes (for humans) and many more different proteins and protein machines. Cells have recently become an important focus of the drug discovery processes following the increasing rate of failures of drugs in late clinical trials or even following market introduction. High throughput cell assays can now be performed automatically in 96 or 384 well plates and is called high content screening (HCS) because it can provide insight on multiple biochemical pathways. HCS is an extension of high throughput screening (HTS) which examines individual bimolecular interactions outside of the cell. HCS is challenging because it requires a tight control of environmental parameters, the delivery of multiple reagents, advanced microscopy, and multi-parameter readouts; consequently it is expensive. Yet HCS represents an annual market value of hundreds of millions of USD, with a rapid growth rate of above 20% annually. The pressure on identifying adverse side effects of drugs early in the drug development process fuels a rapidly rising demand for HCS in the pharmaceutical and biotech industries. There are no intrinsic biological barriers to the further miniaturization and parallelization of HCS and of cellular assays within microfluidic systems, except for the lack of a microfluidic technology that supports MIP on a large scale. For those reasons, the present invention proposes a new microvalve, and the application of this microvalve to microfluidic systems that renders the latter scalable, and that may be used for cell assays and HCS. Furthermore, the present invention provides a novel indirect control architecture where electrostatic elastomeric valves (electrical microvalves, embedded in a control chip) regulate the pressure of fluid in a manifold connected to flexible membrane valves which control the flow of sample fluids. This architecture permits integration of microelectronic integrated circuits (ICs) with microfluidics and hence opens the door to large scale MIP of microfluidics.

With the present invention, electronic microfluidic systems will allow performing cellular assays and HCS with greater flexibility, with much higher throughput, and ultimately at a fraction of the cost of current technologies. We believe that the availability of electronic microfluidic cell chips with thousands of addressable microcompartments will transform drug screening, cell biology and medicine in a similar manner that DNA chips and high throughput sequencers have transformed, and are still transforming, them.

From a terminology standpoint, microfluidics concerns the manipulation and transport of minute amount of liquids. Many microfluidic pumping technologies have emerged in the last 15 years including electro osmosis, electrophoresis, dielectrophoresis, capillary systems, MSL and droplet-based microfluidics. Many strategies are unreliable (e.g. sensitive to the composition of the solution, or to changes in surface chemistry, both of which are difficult to control when using complex biological solutions) and not suitable for integration because they depend on macroscopic peripherals. To date microfluidics have not replaced conventional equipments, except in few niche applications.

The present invention provides a microvalve for a microchannel, which overcomes some of the problems known in the art. Furthermore, the microvalve of the present invention is composed of elements that are affixed to the microchannel and surrounding surface. Also, the present invention provides for a microvalve which reduces the need for high actuation voltages, is amenable to large-scale integration, and is much more resistant over time due to its intrinsic design. Finally, the present invention provides and uses a microvalve, which relies on a membrane demonstrating substantially no resilience to indirectly actuate a flexible valve controlling sample fluid flow.

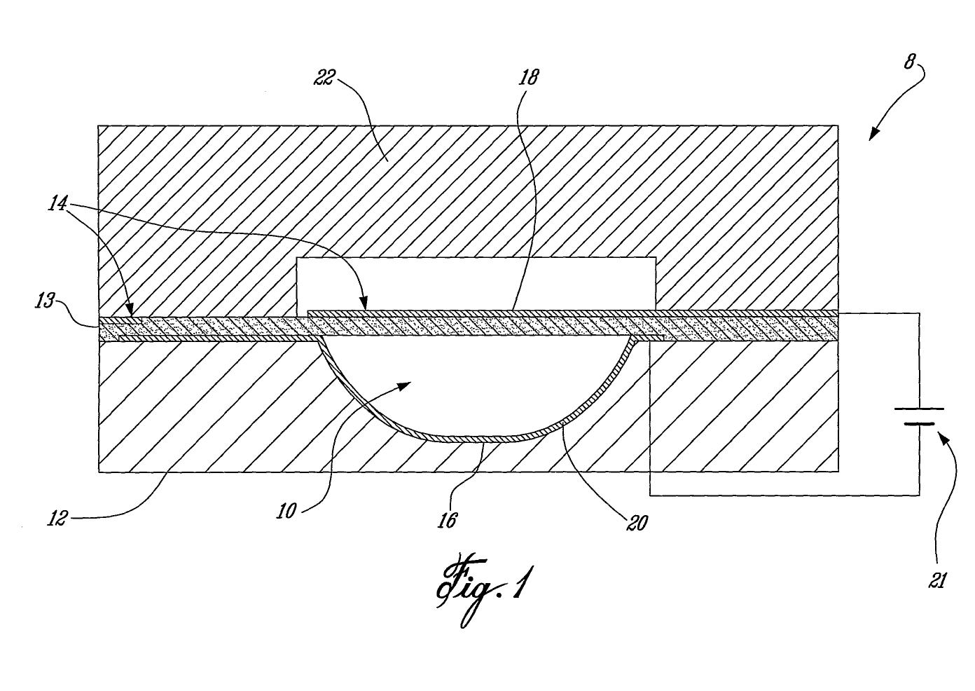

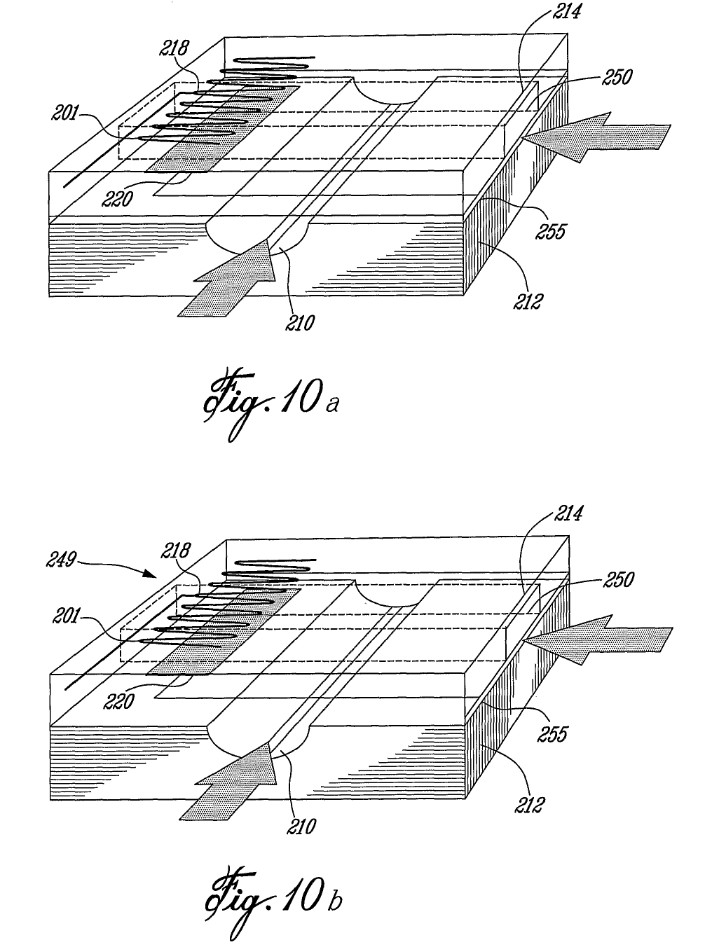

A general embodiment of the present invention will now be described. FIG. 1 depicts a microvalve 8 in accordance with the present invention, in a non-activated state. The microvalve 8 is to be used for obstructing/closing/opening a flow of fluid (not shown) in a microchannel 10. The term “fluid” is used throughout the description so as to include either liquid or gaseous substances, or a combination thereof. The microchannel is manufactured in a base 12, which for example may consist of glass or ceramic or an elastomer or any other material of similar properties. The microchannel 10 has a longitudinal opening exposing a portion or the entire channel 10. The microvalve includes a first electrode 20, a second electrode 18 and a dielectric substance 13. The first electrode is located alongside a section 16 of the microchannel 10. The first electrode 20 could be located in such a manner that it is perpendicular with the microchannel or at an angle therewith, depending of an angle required for the microvalve across the microchannel. The second electrode 18 forms a membrane demonstrating substantially no resilience. The dielectric substance is located in such a manner that it covers at least a longitudinal portion of the microchannel opening and covers a complete cross-sectional portion of the microchannel. The dielectric substance may consist of a solid or semi-solid material. The dielectric substance may for example be composed of an elastic or elastomeric material, such as a membrane of polydimethylsiloxane, PolyMethyl MethAcrylate (PMMA), Polycarbonate, photoresists, SU-8, parylene, SiO₂, Si₃N₄ or any other material having similar electrical and elastic properties. More particularly, in an embodiment of the present invention, the dielectric substance together with electrode 2 forms the membrane demonstrating substantially no resilience 14 that may have a thickness of less than 10 μm. The dielectric substance is preferably extremely flexible, and therefore the membrane 14 requires small voltages between the first and second electrodes for being forced onto the first electrode. The second electrode 18 is either located over, within or underneath the dielectric substance 14, and is substantially aligned with the first electrode 20 (shown concurrently on FIGS. 1 and 9). The first and second electrodes 20 and 18 are composed of an electrically conducting material, for example Al, Cr, Ti, Au, carbon, a conductive polymer or any combination thereof or any other suitable material. In a preferable manner, the second electrode 18 is composed of an electrically conducting material that also tolerates certain flexibility so as to be durable when operating the microvalve, such as a conductive elastomer. Finally, a cover lid 22 may be provided over the second electrode 18 so as to support the membrane 14 when pressure is applied to the channel.

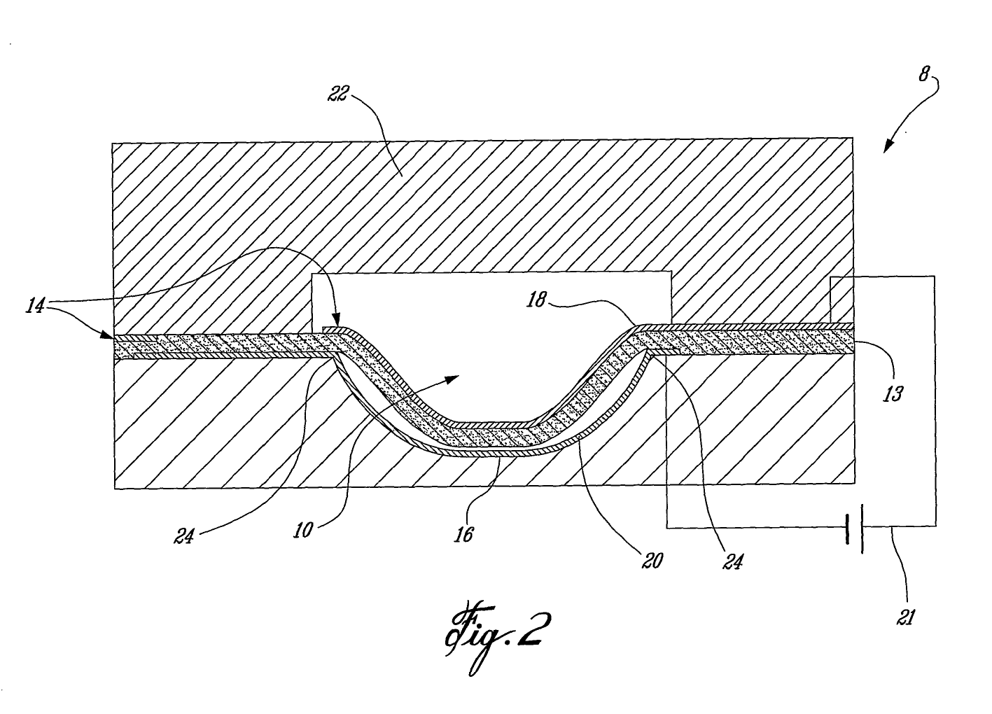

Reference is now made concurrently to FIGS. 1 and 2, where FIG. 2 shows the microvalve 8 in an activated position. To operate the microvalve 8, the first and second electrodes 20 and 18 are electrically connected to an electrical source 21. In function, the electrical source 21 applies an electrical force on the first and the second electrodes 20 and 18, which draw the second electrode 18 nearer to the first electrode 20, thus substantially, obstructing/closing the microchannel. Thus, when the microvalve 8 is not actuated, the microchannel 10 is open and fluid can freely flow therein. However, when the microvalve is actuated, the microchannel 10 is substantially obstructed/closed and fluid cannot freely flow there through.

When the membrane 14 is forced against the microchannel, it may not spring back to the open position by itself because of adhesion forces between the membrane and the microchannel surface and because of the lack of resilience of the membrane 14. The application of a pressure to the microchannel will however detach the membrane 14 from the microchannel surface, and press it against the cover lid and thereby open the microchannel. The use of membranes such as described may appear unpractical because a sample microchannel may remain closed for lack of pressure. However, because of indirect actuation, as described below, the use of membranes 14 becomes practical, and offers a surprisingly attractive solution to make electrical valves. In addition, the microvalve surface can be made rough or ruguous so as to reduce the adhesion forces between the membrane 14 and the microchannel surface.

It will be apparent to those skilled in the art that due to its design and the selected materials, the microvalve of the present invention requires from the electrical source 21 a lower electrical voltage than microvalves of the prior art.

### Manufacturing Process

In general, the method of manufacturing some aspects of the microvalve of the present invention consists of affixing the first electrode 20 on a portion of the surface 16 of the microchannel 10, applying the dielectric substance 13 in such a manner that it covers at least a portion of the microchannel 10 while overlapping the first electrode 20, and affixing the second electrode 18 over the dielectric substance 13.

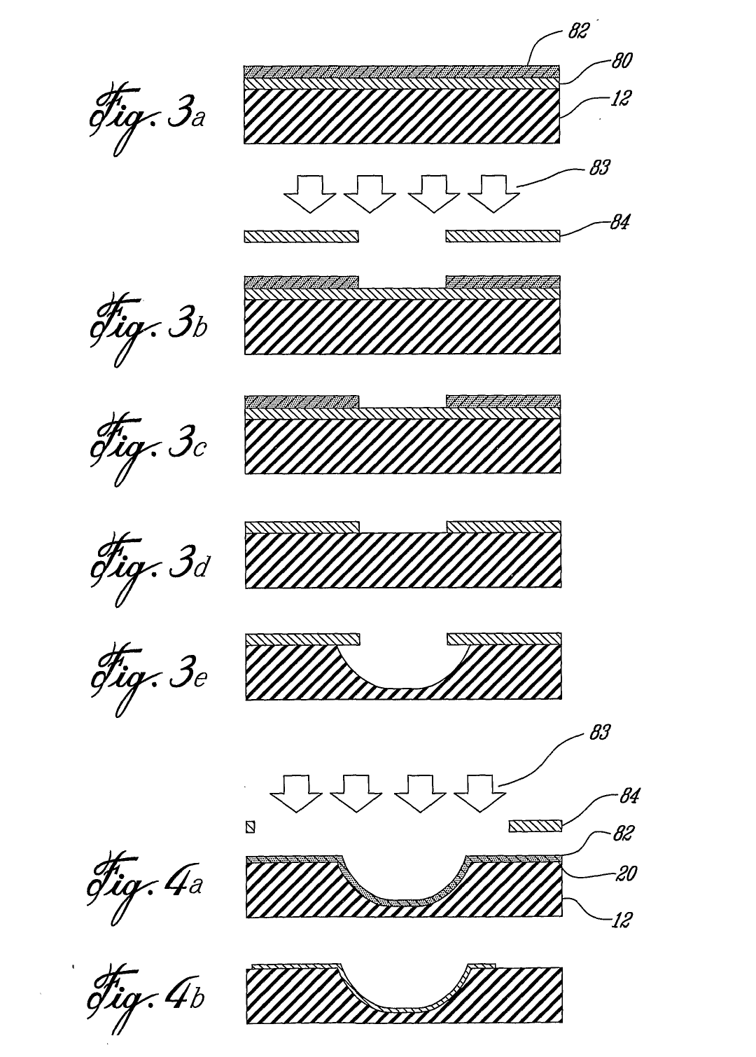

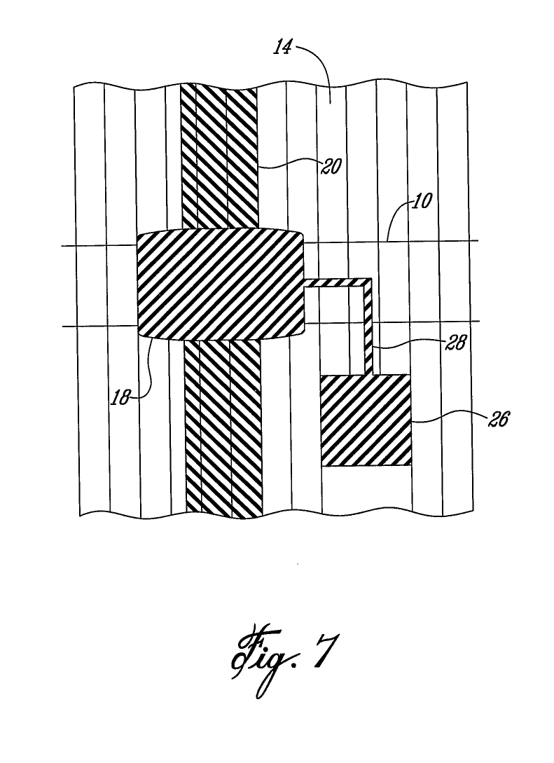

More particularly, FIGS. 3a to 3e depict a possible method for manufacturing the microchannel 10 over the base 12. The process consists of coating a glass substrate 12, or a similar material, with metal 80 and spin coating a photosensitive material 82 thereon. Then, the base 12 is exposed to ultra-violet light through a photolithographic mask 84, so as to expose only the desired region(s). The photosensitive part 82 exposed to ultra-violet light is afterwards developed (i.e. dissolved in the appropriate chemicals). Then, the metal 80 is etched in order to expose the base 12. Finally, the microchannel 10 is etched in the base 12 made of for example borosilicate type glass; using a hydrofluoric acid (HF) based wet chemical solution. The solution may be made of HF, ammonium fluoride (NH4F) and hydrochloric acid (HCl). More particularly, in FIG. 3a, the base 12 is coated with a metal 80 and a spin coated photoresist 82 on top. The microchannel 10 is selectively etched in the base 12 by exposing the photosensitive material 82 to UV light 83 through the photolithographic mask 84. The sidewall angles of the microchannel 10 are controlled by carefully tuning the combination between the bath temperature, agitation and chemical concentration and the hard mask 80 resistance. A very resistant hard mask will produce very vertical sidewalls whereas a hard mask that slowly lifts off during etching will produce smoother sidewalls. Having smooth sidewalls prevents any discontinuities in the metal of the first electrode 20 when it is subsequently deposited on the portion 16 of the microchannel. Typically, a microchannel is between 10 and 150 μm wide and 1 to 30 μm deep. It is possible to round off edges 24 (shown on FIG. 2 and FIG. 6a). Rounded edges 24, as shown in FIG. 6b-c, decrease the stress induced in the second electrode 18 when it is activated and tries to conform to the first electrode 20. Rounded edges 24 also allow the dielectric substance 13 to better follow the profile of the microchannel 10 and therefore seal better the microchannel 10.

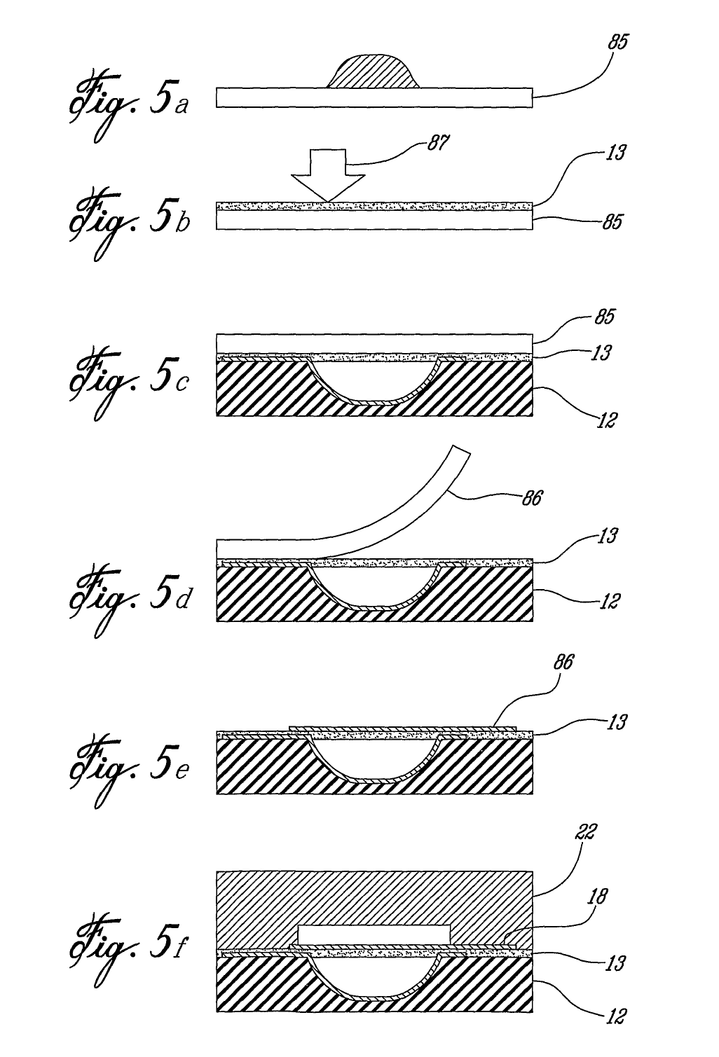

Reference is now made to FIGS. 4a to 4b, which depict an exemplary method of manufacturing the first electrode 20. The first electrode 20 is fabricated using standard lithographic and metal etching techniques. The electrode is composed of an electrical conducting material. The first electrode 20 is deposited on the portion 16 of the microchannel and then the photosensitive material 82 is used to coat the first electrode 20 using for example a multicoat technique to improve the coverage near the edges 24 of the microchannel 10. This also helps in preventing discontinuities in the material of the first electrode 20. The first electrode 20 may be manufactured for example of any of the following metals: Al, Cr, Ti, Au, Cu, and any combination thereof or any other suitable material. Typically, the first electrode 20 is between 50-500 nm thick. In a preferable manner, the first electrode 20 is further electrically isolated with a layer of silicon oxide, silicon nitride, tantalum oxide, any combination thereof or any other suitable material that can be deposited by sputtering, chemical vapor deposition, or spin-on techniques.

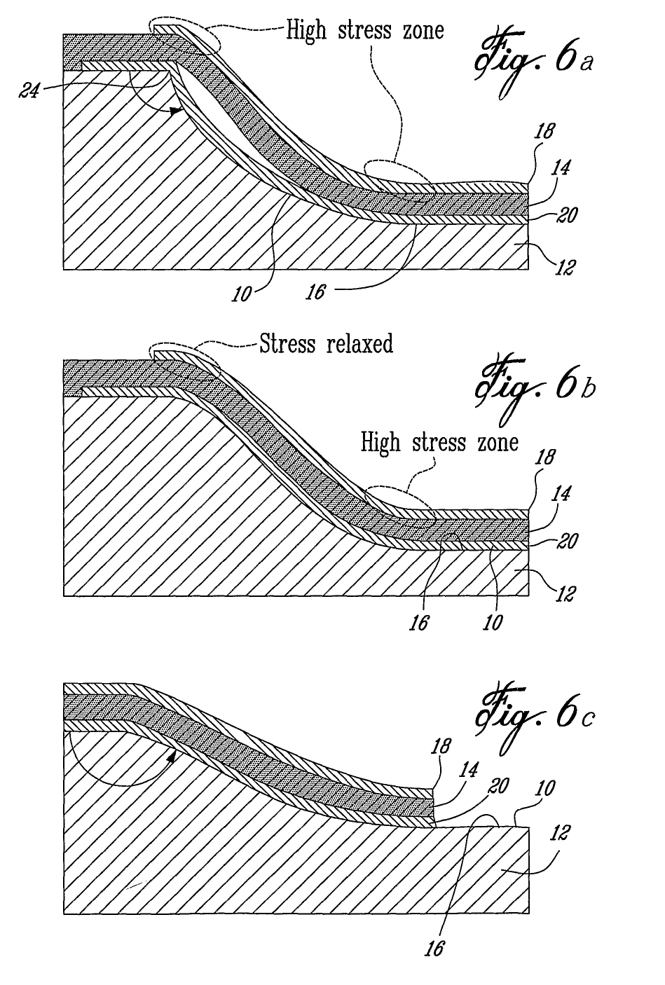

Reference is now made to FIGS. 5a to 5f, which depict an exemplary method of manufacturing the dielectric substance 13, and the remaining steps of the manufacturing of the microvalve 8. To create the dielectric substance 13, a material such as for example polydimethylsiloxane (PDMS) is first poured on a thin plastic film 85 that has received an antiadhesion treatment (either plasma or liquid) and spincoated such as to create a thin PDMS membrane. The thin plastic film 85 may be held on a silicon wafer. The thickness of the spun-on PDMS material 13 can be finely tuned to be within 500 nm to 30 μm, preferably about 3 μm. The plastic film PDMS membrane assembly is then flipped and transferred on the base 12 (FIG. 5c), containing the microchannel 10 and the first electrode 20. During this step, the plastic film PDMS membrane assembly, the microchannel and the first electrode 20 are then exposed to oxygen plasma 87 to activate their surfaces prior to bonding, and then permanently bonded. The adhesion of the PDMS membrane 13 onto the base of the microchannel 10 can be improved by a soft bake of several (30 to 60) minutes in an oven at a temperature of about 70° C. The plastic film 85 is eventually pealed off easily, FIG. 5d, since the bonding strength is higher at the membrane-base interface, thus leaving the dielectric substance 13.

The second electrode 18 is fabricated directly on the dielectric substance 13 by first depositing a thin metal layer 86 of electrode material such as Cr/Au as shown in FIG. 5e. Approximately 1 to 20 nm may be deposited.

The metal layer 86 is patterned using lithography and wet etching. Once the second electrode 18 is deposited on the dielectric substance 13, the lid 22, with cavities matching the microvalve 10 location, is bonded to the base 12 using oxygen plasma surface activation. The base 12 and the lid 22 may be made of for example PDMS or glass. Alternatively, it may be possible to replace the second electrode 18 by a conductive polymer or elastomer electrode.

In another embodiment of the present method of manufacturing, after step 4b where the metallic bottom electrode is etched using a wet chemical solution, a dielectric insulation thin layer is deposited via sputtering, evaporation or chemical vapor deposition. The layer could be silicon dioxide (SiO2), silicon nitride (Si3N4), tantalum pentoxide (Ta2O5) or any highly resistive material exhibiting a high breakdown voltage. Steps 5a to 5b are similar as previously described. Before step 5c, there is an additional step which consists in patterning an electrode on the elastic substance. This electrode is the second electrode of the microvalve. In order to increase adhesion of metal onto the substance, several strategies can be used: a metallic adhesion layer that could be chromium or titanium can be added, or a self assembled monolayer silane or any chemicals that is susceptible to increase metallic adhesion could also be used. Once the electrode is patterned, the substance and the base are oxygen plasma treated and bonded together (step 5c). The bonding strength is increased with a 30 to 60 min cured in an oven at 70° C. During step 5d, the plastic film 85 is peeled off easily since the bonding strength is higher at the membrane-base interface, thus leaving the dielectric substance 13 and the second electrode 18 attached underneath.

For the embodiment where the second electrode is within the dielectric substance 13, the manufacturing process requires an additional step after patterning the second electrode: another elastic substance that could be PDMS is poured and spin coated on the electrode 18 and cured at 70° C. for 30 to 60 minutes. The process then continues with step 5c.

### Method of Manufacture of the Microfluidic Circuit

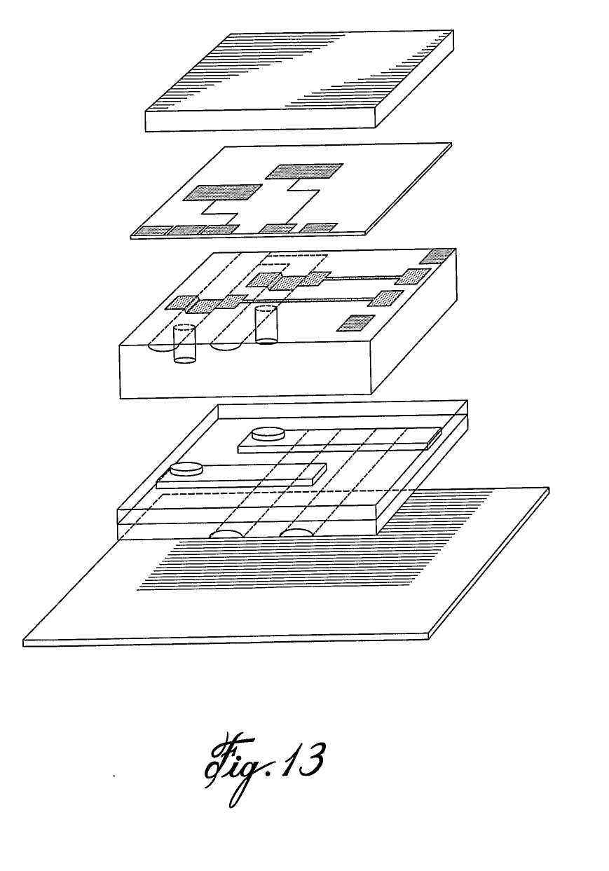

In the context of the prototype, hereinafter described in greater details, a prototype of the electrical microvalve has been manufactured by transferring 10-micrometer-thick membranes spanning a channel that is ˜12 μm deep and 100 μm wide (shown on FIG. 13), and demonstrated electrostatic deflection of the membrane under applied voltage. 2nd generation electrical microvalves with membranes only 3 μm thick and arranged as arrays in a micro-electro pneumatic chip were also manufactured. A new simplified fabrication process that allows making each layer on a wafer was developed, to assemble the chips by stacking different layers, thus greatly simplifying the process. An enhanced sacrificial layer release pioneered by Genolet et al. at IBM which allows the quick release of large structures on a wafer scale was implemented. It was noticed that the micrometer-thin PDMS membranes are very fragile, and can easily be ruptured during fabrication, which can be avoided using this release process.

An important challenge is the fabrication of thin PDMS membranes with the high yield necessary for large scale integration. The current fabrication method for making thin valves is based on spin-coating 3-5% PDMS diluted in toluene and patterning Au by wet etching on top of it to define the electrodes. There are many parameters that may be changed, such as the solvents used for spinning or even the supporting polymer. Indeed, for a valve with a low aspect ratio of 1:50 (current design) the strain produced by closing the valve is very small (only 0.12 percent assuming a circular cross section for the channel), which can be achieved using a wide range of materials, including polymers such as SU-8 or PMMA (both of which can be coated down to nanometer thicknesses), or dielectric films coated by evaporation or sputtering. With this geometry, the electrical material alone may form the membrane 14, whereas the dielectric substance 13 is attached to the first electrode.

### Reduction of Stress

Reference is now made to FIGS. 6a-6c, which depict partial cross-sectional side views of the actuated microvalve 8 in the microchannel 10 in accordance with other embodiments of the present invention. More particularly, FIG. 6a illustrates that it is preferable, to reduce stress on the microvalve 8, that the microchannel 10 be provided with edges 24 that are rounded. At the edges of the channel, the pressure of the closing of the microvalve causes a large strain (stretching) whereas at the bottom of the channel, it causes the first electrode to be compressed. Such a situation is not preferred, as excessive stretching can tear the first and the second electrodes apart, thus reducing the lifetime of the valve. FIG. 6b shows the actuated microvalve in the microchannel 10, wherein the sharpness of the edges 24 of the microchannel 10 have been reduced, and the remaining stress area for the microvalve is located at the bottom of the microchannel 10. FIG. 6c depicts a preferred design for the microchannel. The preferred design includes rounded edges and reduced sidewall angle so as to totally reduce the stress on the microvalve at both the microchannel edges and at the bottom thereof. This design has another interesting advantage: it reduces the electrical tension required from the electrical source to close the microvalve.

Another way to reduce stress is to provide second electrodes that are longer than the width of the microchannel. The electrodes may take the shape that is rectangular, spiral, sinusoidal or saw-tooth shaped. This improvement reduces the stress on the electrode and reduces chances of tearing the membrane 14.

Particularities of the Second Electrode

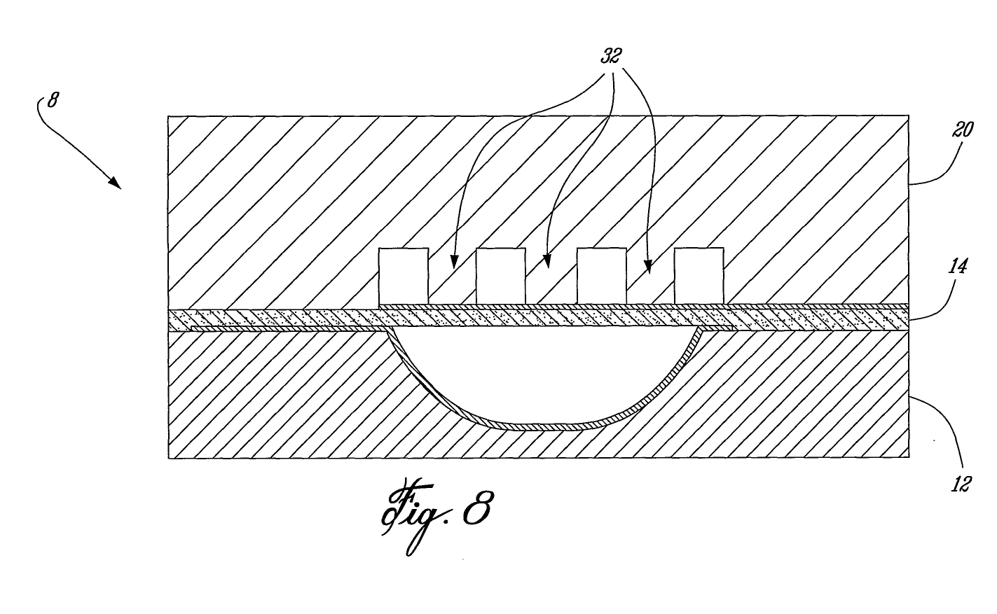

Reference is now made to FIG. 7, which depicts a top view of the microvalve 8 installed on the microchannel 10 and ready to operate. In that view, the first electrode 20 is at the bottom of the microvalve, the second electrode 18 is connected to a pad 26, for future wire bonding or probing or contacting, through an access line 28. The access line 28 is routed such as to follow a path of minimum strain to reach the second electrode 18. It should be noted that as the deflection is at its greatest where the pressure created by the first and second electrodes is the greatest, it is advantageous to locate the access line 28 in such a manner that it is outside of the deflection area, thus reducing the resulting strain at the edge of the microchannel and consequently on the access line itself. Because the second electrode 18 needs to be flexible as it is stretched when the microvalve 8 is activated, the second electrode 18 may be rectangular, round, circular, spiral shaped, saw-teeth shaped, or sinusoidal shaped. The ratio between electrode and non-electrode area can be varied. For example, the ratio could be as low as at least 1:20, 1:50 or even at least 1:100. Such designs help reduce tearing of the second electrode 18 and help in increasing its lifetime.

FIG. 7 shows an example of a long second electrode 18 crossing a narrower first electrode 20. The second electrode 18 and the dielectric layer 13 (shown in cross-section in FIG. 1) together form a two-layer structure that is more resilient than the dielectric layer 13 alone. At the edge of the first electrode 20 located within the microchannel 10 within the microvalve cross-section, there may be a strong strain on the dielectric material 13 when the second electrode 18 is actuated and closed whereas the dielectric layer 13 not overlapping with the second electrode 18 is pressed against the lid (Number 22 with reference to FIG. 1) by the pressurized fluid in the microchannel 10. A way to reduce stress on the dielectric layer 13 within the microchannel cross-section is to make the second electrode 18 extend longitudinally in the microchannel over a distance that is greater than the width of the first electrode 20, so that the strain upon deflection of the membrane 14 is carried both by the second electrode 18 material and the dielectric material 13 of electrode 18.

Microvalve with Recesses

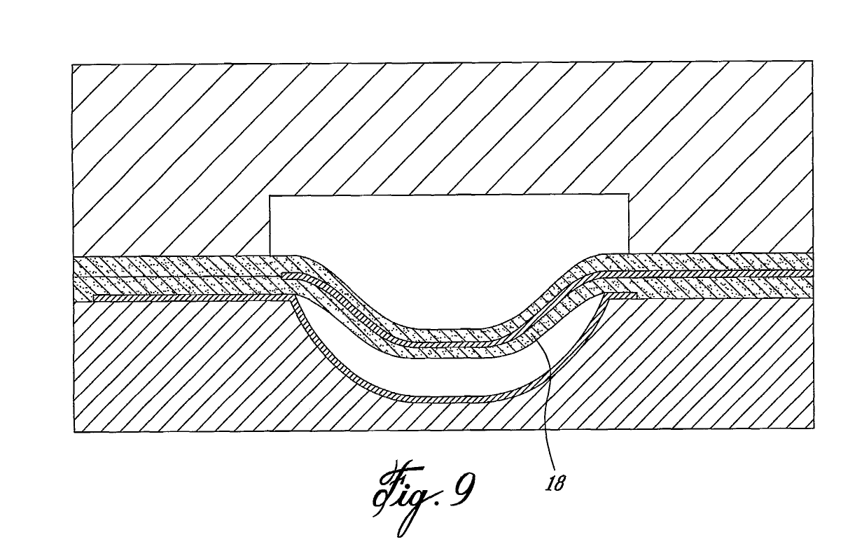

To prevent the membrane 14 from deflecting upwards under pressure caused by fluid flowing in the microchannel 10, or inwards under its own weight, the lid 22 may be provided with posts or walls 32, as shown in FIG. 8. The posts or walls stop the membrane 14 from deflecting upwards under pressure, and the membrane 14 can stick to the posts or walls 32, which prevent it from deflecting into the microchannel 10. The recesses allow opening and closing the microvalve 8 rapidly because they provide enough volume for air to fill and move away when the microvalve is closed and opened, respectively. Without recesses, the microvalve 8 may still open, but more slowly because the void that is then formed creates a vacuum that has to be filled by gas drained from the surrounding material of the cover lid. The gas reservoir afforded by the recesses allows rapid opening and closing of the microvalve. In addition, the surface of the recesses can be roughened so as to reduce the adhesion between the membrane 14 and the recesses. Examples of typical width of the posts or walls can be 1-100 μm, the gap between the posts or walls 1-100 μm, and the length of the walls can be 20 μm to 1 mm. Examples of roughness are 1 nm-2 μm in length and 1 nm to 10 μm in height.

### Use of Microvalves for Pneumatic and Hydraulic Applications

In prior art MSL chips, the pressure in a pneumatic or hydraulic control line deflects a thin elastomeric membrane—serving as a valve—into a sample channel and closes and opens it. Such microfluidic architecture and variants of it have been successfully used for a variety of applications including pumping, protein crystallization, immunoassays, quantitative PCR, bacterial culture, etc. The success of this approach is rooted in the versatility of the technology, in the low cost of the chips made out of polydimethylsiloxane (PDMS), and in the ease with which it can be fabricated and operated using a computer. Large-scale parallelization is accessible with MSL using a dual control layer (a pneumatic multiplexer controls the pressure in pneumatic lines which deflect membranes into samples channels and thereby control sample flow) similar to RAM architecture. Thus, n chambers can be addressed using 2 log 2 n pneumatic or hydraulic control lines only, e.g. 1024 chambers using 20 control lines. One drawback is that this architecture is organized around few inlets and outlets, and large volumes of samples are expended in the maze of channels. But significantly, the control depends on macroscopic solenoid valves that need to be connected with macroscopic pins to the chip. Only a single MSL chip can be operated at one time.

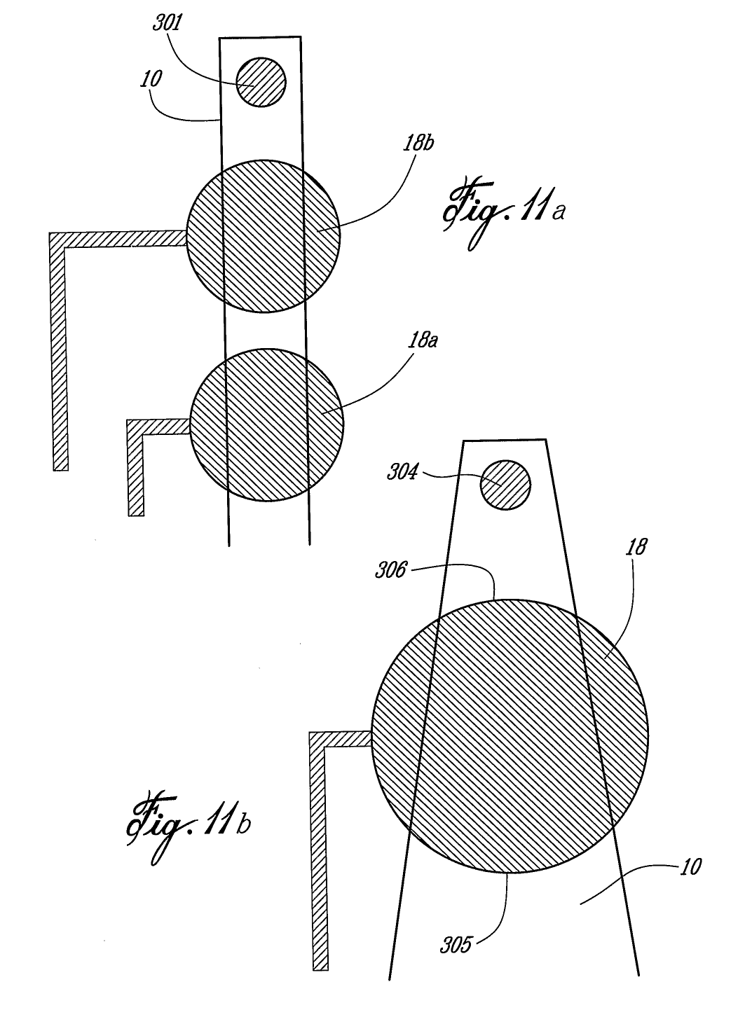

Reference is now made to FIGS. 10 a-b, which depict a perspective view of an application of the microvalve of FIG. 1 respectively in accordance with two embodiments of the present invention. The first embodiment depicted in FIG. 10 a relates to a normally open microvalve and the embodiment of FIG. 10 b relates to a normally closed microvalve. Those embodiments are also called microfluidic circuit with indirect electrostatic actuation.

In this particular application, a base 212 may contain many microchannels 210 (of which only one is shown for clarity purposes). The microchannel 210 is adapted to receive fluid. The microchannel 210 is covered with a flexible membrane 255, which is adapted to obstruct/close the microchannel 210 upon pressure actuation 249 in a partially superposed channel 250. The flexible membrane 255 can be with or without resilient force, depending on the application to be implemented. As in some instances, the microchannel 210 may be used to carry sample fluids with electrical conductivity; it is preferable to use the electrical microvalve of the present invention so as to indirectly actuate the flexible valve so as to not affect the operation of the electrical valve by the conductive fluids.

For such applications, the present invention, shown on FIGS. 10a-b and FIG. 13, proposes an indirect valving architecture where the electrical microvalve is embedded in a micro-electro pneumatic or micro-electro hydraulic chip and operated using HV ICs, and can replace the external solenoid valves in the multiplexed MSL architecture described previously, by controlling the pressure inlets, or by replacing the multiplexing control valves, or by directly controlling the pressure acting on the sample control valves, or a combination of these schemes.

More particularly, in the case of FIG. 10a, when the microvalve 201 is not actuated, the pressurized fluid circulates in the microchannel 250 without forcing the flexible membrane 255 in the microchannel 210, thus allowing passage of sample fluid therein. However, upon actuation of the microvalve 201, passage of fluid is obstructed in the microchannel 250, which results in the flexible membrane 255, to take expansion in the microchannel 210, thereby obstructing the latter.

In the embodiment shown on FIG. 10b, an alternate indirect actuation is depicted. In that alternate embodiment, the microchannel 250 is closed at an extremity thereof. When the microvalve 201 is not actuated passage of fluid in the microchannel 250 is permitted and because the end of the microchannel is closed, the pressurized fluid forces the flexible membrane 255 in the microchannel 210 thus obstructing passage of sample fluid therein. However, when the microvalve 201 is actuated, the passage of gas is blocked, and the pressurized air dissipates in the flexible membrane 255, and in the surrounding material 214, which removes the pressure on the flexible membrane 255 which frees the microchannel 210 allowing passage of sample fluid therein. In another implementation, a small drainage channel may be formed in the extremity of the microchannel so that when the microvalve is actuated, the passage of fluid is blocked, and the pressurized gas or liquid can dissipate through the drainage channel, which removed the pressure on the flexible membrane 255 as described above.

The approach of the present invention is thus compatible with large scale MIP and with cell culture, is low cost, and can regulate pressures of at least 50 kPa, and thus overcomes all of the above mentioned shortcomings. A single, unregulated pressure line connected to the micro-electro pneumatic chip is sufficient because an air manifold distributes the gas within the chip, and directs it to different branches connected to a disposable MSL chip. The pressure in each branch acts on a pneumatic valve in an MSL chip, but is regulated with an electrical microvalve 201 under the control of the HV ICs. Electrical microvalves 201 in the micro-electro pneumatic chip operate independently of the sample fluid composition, and small electrical microvalves can be used to actuate much larger pneumatic valves, or even multiple valves connected together. The electrical microvalve 201 exploits the elastic properties of ultra thin films on the dielectric membrane, such as ultra thin Au films which can be strained up to 20% without rupture, well beyond the current requirements.

Using this indirect actuation scheme, low aspect ratio channels with thin, membranes that collapse (and thus eliminate the mechanical resistance opposing the closing of the valve) can be used. These pneumatic valves are functional because in use the fluid pressure opens them up. Lids covering the electrical microvalve 201 (FIG. 13) provide support and prevent excessive deflection and rupture of the membrane under the fluid pressure, and ensures that the two electrodes stay within the electrostatic actuation range. The 100×100 square micrometers membranes with a 100-nm-SiO2 layer form a capacitance of ˜4 nF when closed. Using 300V with a 2-μm-gap, a pressure of ˜200 kPa can be regulated. With these parameters, 180 μJ are stored in a capacitance of an electrical microvalve that is closed, which can easily be driven with the HV ICs. By working at lower pressure, the voltage may be reduced, or the depth of the conduit increased (the force scales with the inverse of the square of the gap). By reducing the area of the electrical microvalve, or the voltage, the energy can be reduced (and the electrical energy “recycled” by using smart electronics). This configuration is not compatible with direct valving for the reasons mentioned above and because such a shallow channel creates excessive resistance to sample fluid flow (but not to actuation fluid flow that requires only very small volumes).

FIG. 11a shows a microvalve that features two second electrodes 18a and 18b and that is preferentially used for hydraulic applications. The microvalve is used to actuate a flexible valve located downstream of opening 301. Microvalve 18a is actuated first and closes channel 10. Microvalve 18b is actuated thereafter and displaces the fluid between electrodes 18a and 18b, which creates a pressure in the channel 10 and in the opening 301 and thus displaces the flexible valve to close a microchannel containing sample fluid.

FIG. 11b shows another embodiment of a hydraulic microvalve. Here the geometry of channel 10 is such as the width is wider on the edge 305 of the electrode 18 and narrower on the edge 304. Thus, upon application of electrical force, the valve initially closes on the edge 305. Once it is closed on the edge 305, the closure of the other areas of the valve will contribute to increase the pressure downstream of the valve and in the opening 301 and on the flexible membrane that interrupts a flow of sample fluid. It will be apparent to the skilled in the art, that instead of a V-shaped width, a channel with variable depth may be used or an electrode with areas without electrode material (The larger the area without electrode material, the smaller the electric force and the later the electrode will close). For example if the non-electrode are is higher on the edge 306, the edge 305 will close faster as described above. Different driving voltages may be used to increase the time lag between the closure between the edge 305 and the edge 306 of the electrode.

FIG. 13 shows an electronic microfluidic chip in accordance with another aspect of the present invention. An exploded view of a micro-electro pneumatic chip with electrical microvalves and of a MSL chip with pneumatic membrane valves is shown. The electrical microvalve comprises two electrodes, one coated atop of the elastomeric membrane and one at the bottom of the microconduit connected to a power supply.

Although throughout the present specification, the expression microfluidic circuit is being used, it is meant to also include microfluidic chips, and all other similar expressions commonly used in the field.

### Architectures

Another example of application of the microfluidic circuit with the microvalve of the present invention is to realize an architecture that can be interfaced directly with microelectronic chips and that is therefore scalable. As the microvalve of the present invention can be closed by applying a voltage, it can therefore be directly controlled using electronic chips. Thus, using a computer, complex fluidic operations can be programmed and using a microelectronic chip the microvalves in the microfluidic circuit actuated accordingly. This concept hinges on the large-scale integration of microelectronic chips and allows accelerating the integration and parallelization of microfluidics.

Using the microvalve of the present invention renders microfluidic circuits extraordinarily versatile and ideally suited for performing complex experimental protocols in parallel with high throughput while economizing reagents and reducing costs. Such microfluidic circuits could transform high cell biology—specifically high throughput cell assay—and medicine akin to the way that DNA chips and high throughput sequencers have transformed, and are still transforming, them.

An additional aspect of the present invention lies in the overall concept and architecture for integrated electronic microfluidic systems with two fluidic chips—a disposable MSL chip reversibly connected to an micro-electro pneumatic or a micro-electro-hydraulic chip with electrical microvalve—controlled using HV ICs, and in the technical details supporting their realization. More particularly, the following aspects are of interest: the indirect valving concept using a micropneumatic circuit (with a gas manifold) or micro hydraulic circuit (with a liquid manifold) controlled by electrical microvalve which is a significant advance because it acts as a bridge between microelectronic ICs and microfluidics, thus paving the way for large scale MIP of microfluidics; the concept and design of the flimsy, non-self-supporting electrical microvalve formed across low aspect ratio conduits; and finally, the simplified fabrication process to make these valves.

### Other Microvalve Combinations Examples

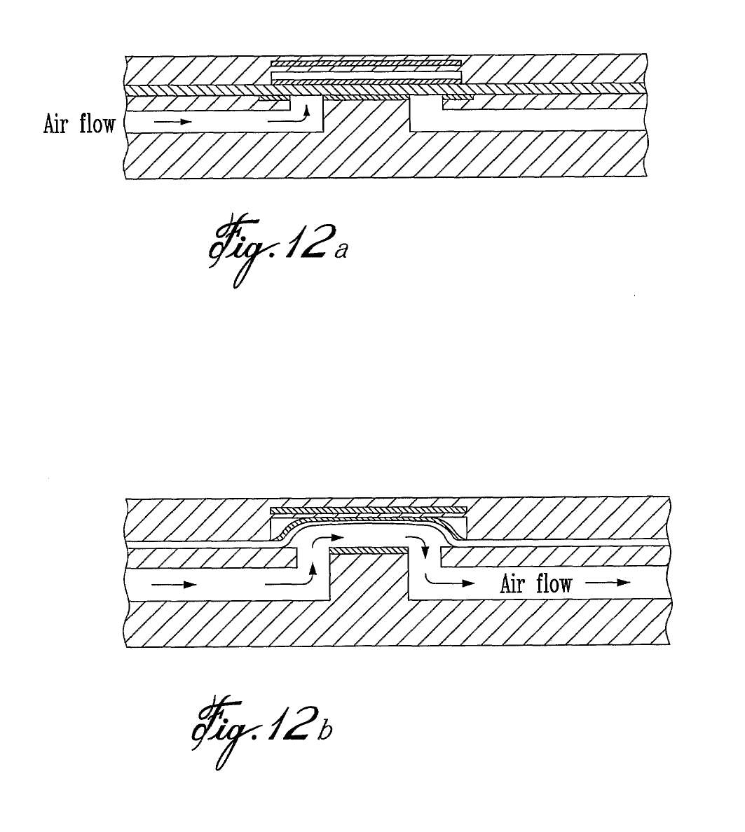

Reference is now made to FIGS. 12a-b, which depict a cross-sectional view of another indirect pneumatic actuation embodiment of the present invention. In this embodiment, the use of a three-electrode electrical microvalve for pneumatic network is described. The pneumatic network is meant to actuate microvalves in a microfluidic network.

On FIGS. 12a-b, the three electrodes can be named electrodes 1, 2 and 3 from the bottom one to the top one. This embodiment represents a “latch” valve. The two generic electrodes (no 1 and 3) are kept at potential 1 and potential 2, whereas electrode 2 can be addressed with potential 3, which can vary between potential 1 and 2. In an inactive state, the value of electrode 2 is in between so that there is an electrical field between electrodes 1 and 2 and between electrodes 2 and 3. However, if electrode 2 is closing the channel (FIG. 12a) the distance to electrode 1 is much shorter and hence the electrical field and the force. Thus it remains in that position. Conversely, if electrode 2 is open (FIG. 12b) then it is much closer to electrode 3, and hence the electric field between 2 and 3 is much higher than between 2 and 1 and thus electrode 2 is stuck to the ceiling. To actuate electrode 2, a brief pulse at the potential of the nearest electrode will disrupt the electrical field so that it is attracted to the remotely located electrode. For example if it is located on electrode 1, by setting the potential of electrode 2 equal to electrode 1, the electrical field will be strongest between 1 and 3, and thus the valve will be opened and electrode 1 pressed against electrode 3. By setting briefly the potential of electrode 2 at the value of potential 3, the valve will be closed by the same mechanism. Thus by keeping the electrode 2 at an intermediate potential, it will just remain to whichever electrode it is pressed upon. This configuration can therefore serve as both a normally open valve and a normally closed valve, depending on the need of the moment. This greatly facilitates actuation of an array of valves where some valves need to be closed most of the time and some other valves open most of the time. Only electrodes 2 need individual addressing, which greatly facilitates integration. Additionally, electrodes 2 could be addressed individually or as groups.

### Prototype

In the context of the present invention, a prototype electronic microfluidic system using the teachings of the present invention has been built and used for automated cell culture and assays. The following phases were followed in the development of the prototype:

Phase 1: Develop electrostatic elastomeric valves (electrical microvalve), also called microvalve, for regulating the pressure in a manifold embedded in a micro-electro pneumatic (MEP) chip; an electrical interface and connections to a sample chip;

Phase 2: Design and microfabricate a multilayer soft lithography (MSL) sample chip with pneumatic membrane valves suitable for cell culture. The MSL chip was disposable and could be connected to the MEP chip;

Phase 3: Integration of high voltage (HV) ICs, and the above mentioned MEP and MSL chips on a custom designed PCB connected to a computer with a control program that is used to program the HV ICs. The HV ICs control the electrical microvalves which control the membrane valves in the MSL chip; and

Phase 4: Testing of the electronic microfluidic chips and demonstration of complex fluidic operations with the delivery of cells to the microfluidic compartments, and assess the merit of electronic microfluidics for HCS.

Phase 1 consisted of building MEP chips with electrical microvalve. The major task was the fabrication of a MEP chip with at least 40 independent electrical microvalves that could regulate at least 0.5 bar using 300 V. The current test chips microfabricated were 25×25 mm2 in size, feature sets of 32 electrical microvalves with variable dimensions and a standardized interface with 168 electrical connections by patterning Au on PDMS (which forms excellent electrical contacts 13). The thickness of the membrane and the depth of the pneumatic channel were adjusted during fabrication. Molding processes that were developed previously were used to define (vertical) via in both the MEP and MSL chips and which served as pneumatic connections between the electrical microvalves and the membrane valves of the MSL chip. The design of the electrical microvalve and pressure manifold were optimized for efficiency and the fabrication process for higher yield, which necessitated continuous efforts and careful processing of the chips in the clean rooms. Next, the 2nd generation MEP chip were designed and microfabricated. The current processes was further refined for increasing the yield and different surface chemical treatments based on silanes and thiols were used to control adhesion depending on the requirements.

Phase 2 consisted of building an MSL chip suitable for cell culture, and interconnection via matching the ones of the MEP chip. MSL is a well-established technology, and published design rules were followed to make an MSL chip. Synthesis of a set of universal requirements of HCS and cellular assays were elaborated to guide the design of the MSL chip. The fluidic network architecture was defined by improving on the functions and features of published MSL chips and applications. Channel dimensions of ˜50 μm width, ˜20 μm depth, and cell culture micro compartments ˜400 μm wide (with support posts) are foreseen. The MEP chip and MSL chips were aligned using a homemade alignment tool and reversibly clamped together on the PCB. For small chips, mechanical clamping was used, whereas for larger chips a vacuum-based clamping using a manifold is being foreseen.

Phase 3 consisted of building an electronic microfluidic system comprising a custom-designed PCB, the MEP and MSL chips developed in phase 1 and 2, five HV ICs bonded to a glass carrier and connected to the PCB, and a computer connection. Programming in Labview™ was developed for controlling the 5 HV IC chips each featuring 10 programmable HV control lines operating at up to 300 V and supporting a load of 2 mA.

Phase 4 more particularly consisted of testing the electronic microfluidic system and demonstrating complex fluidic operations and delivery of cells to the micro compartments. Using a pressure regulator, the manifold was pressurized, as well as the sample containers. Although a single pressure line would be sufficient, additional pressure lines were used in this prototype to simplify operation. The PCB was mounted on an inverted microscope equipped with an incubation chamber enabling both observation and cultivation of cells in the electronic microfluidic system. The system was qualified, the merit of the technology assessed and an analysis of the shortcomings provide and improvements proposed. This evaluation was performed with respect to live cell assays and HCS.

The present invention has been described with regard to preferred embodiments. The description as much as the drawings were intended to help the understanding of the invention, rather than to limit its scope. It will be apparent to one skilled in the art that various modifications may be made to the invention without departing from the scope of the invention as described herein, and such modifications are intended to be covered by the present description.

1. A microvalve for a microchannel, the microvalve comprising:
a first electrode affixed to a portion of the microchannel;
a second electrode located within proximity of the microchannel and substantially aligned with the first electrode, the second electrode forming a membrane demonstrating substantially no resilience; and
a lid adapted to support the membrane,
whereby upon electrical actuation of the first and second electrodes, the second electrode is forced towards the first electrode within the microchannel so as to obstruct the microchannel.

2. The microvalve as defined in claim 1, wherein the membrane further comprises a dielectric substance adjacent the second electrode, whereby upon electrical actuation, the dielectric substance is drawn in the microchannel by the second electrode.

3. The microvalve as defined in claim 2, wherein the dielectric substance is made of one of the following materials: polydimethylsiloxane, PolyMethyl MethAcrylate, polycarbonate, photoresists, SU-8, parylene, SiO₂, Si₃N₄ or any other material having similar electrical and elastic properties.

4. The microvalve as defined in claim 1, wherein the membrane does not return to an open position when the electrical actuation is terminated.

5. The microvalve as defined in claim 1, wherein the membrane does return to an open position when the electrical actuation is terminated and pressure is applied to the microchannel at the same time.

6. The microvalve as defined in claim 1, wherein a contact surface of the membrane is rough or corrugated so as to minimize the tackiness between the membrane and the microchannel.

7. The microvalve as defined in claim 2, wherein the dielectric substance has a thickness of less than 10 μm.

8. The microvalve as defined in claim 1, wherein the second electrode does not extend over edges of the microchannel, and further comprises an electrical line extending laterally away from a deflection area created by the first and second electrodes in operation.

9. The microvalve as defined in claim 2 wherein the second electrode is substantially embedded in the dielectric substance.

10. The microvalve as defined in claim 2, where the dielectric substance is further adjacent to the first electrode.

11. The microvalve as defined in claim 1, wherein the first electrode is coated with a dielectric substance that is also adjacent to the second electrode.

12. The microvalve as defined in claim 10, wherein the dielectric substance is rigid and composed of one of the following materials: SU-8, PMMA, Parylene, polycarponate, polyester, PET, SiO2, Si3N4, etc.

13. The microvalve as defined in claim 1, whereas the lid features recesses that trap gas and facilitate a rapid closing of the microchannel by the membrane demonstrating substantially no resilience upon actuation of the microvalve.

14. The microvalve as defined in claim 1 wherein the second electrode is of one of the following shapes: rectangular, spiral, sinusoidal or saw-tooth shaped.

15. A microvalve for a microchannel, the microvalve comprising:
a first electrode affixed to a base of the microchannel;
a second electrode located within proximity of the microchannel and substantially aligned with the first electrode and forming a membrane demonstrating substantially no resilience;
a third electrode affixed to a cover portion of the microchannel and substantially aligned with the first and second electrode;
dielectric substance located between the first and second electrode and the second and third electrode; and
whereby upon electrical actuation of the first and second electrodes, the second electrode is forced towards the first electrode within the microchannel so as to obstruct the microchannel, and upon electrical actuation of the second and third electrodes, the second electrode is forced towards the third electrode within the microchannel so as to open the microchannel.

16. A method of manufacturing a microfluidic circuit, the method comprising steps of:
(a) etching a microchannel in a base that could be glass or ceramic or any other substance having similar properties;
(b) affixing a first electrode in a microchannel;
(c) applying a dielectric substance covering at least a portion of the microchannel over the first electrode; and
(d) affixing a second electrode over the dielectric substance in such a manner that the second electrode is substantially aligned with the first electrode.

17. The method as defined in claim 16 wherein the step of affixing the first electrode comprises steps of:
(a) depositing an electrically conducting material over a substantially cross-sectional portion of the surface of the microchannel;
(b) spincoating a photosensitive substance over the electrically conducting material;
(c) exposing the photosensitive substance and electrically conducting material to a source of ultra-violet light;
(d) developing the photosensitive substance;
(e) etching the electrically conducting material; and
(f) stripping the photosensitive substance.

18. The method as defined in claim 17, wherein the step of applying the dielectric substance covering at least a portion of the microchannel comprises steps of:
(a) pouring polydimethylsiloxane (PDMS) on a plastic film;
(b) spincoating the PDMS for obtaining a thin membrane;
(c) baking the thin membrane and the plastic film;
(d) after the baking step, applying an oxygen plasma treatment to the thin membrane and the base containing the microchannel; and
(e) flipping the thin membrane and the plastic film, and bonding to at least the portion of the microchannel.

19. The method as defined in claim 18, wherein the step of affixing a second electrode over the dielectric substance comprises steps of:
a) depositing a layer of the electrically conducting material over the elastomeric substance;
b) shaping the layer of the electrically conducting material to a desired shape; and
c) bonding a PDMS lid onto at least the portion of the microchannel.

20. Use of the microvalve of claim 1 in a microfluidic circuit for indirect actuation of a flexible valve.

21. A microfluidic circuit comprising:
two partially superposed microchannels; and
at least one microvalve as described in claim 1 affixed to one of the two microchannels, wherein the at least one microvalve is adapted to indirectly actuate a flexible valve adapted to regulate a flow of fluid in another one of the two microchannels.
